(19) United States
(12) Patent Application Publication
(10) Pub. No.: US 2023/0047425 A1
(43) Pub. Date: Feb. 16, 2023

(54) Novel construction and sealing method for modular pressure reservoir

(71) Applicant: Wheel Pros, LLC, Greenwood Village, CO (US)

(72) Inventors: Reno Heon, San Luis Obispo, CA (US); Dustin Heon, Arroyo Grande, CA (US)

(73) Assignee: Wheel Pros, LLC, Greenwood Village, CO (US)

(21) Appl. No.: 17/828,478

(22) Filed: May 31, 2022

Related U.S. Application Data
(60) Provisional application No. 63/233,712, filed on Aug. 16, 2021.

(51) Int. Cl. F17C 13/06

(52) U.S. Cl. CPC F17C 13/06; F17C 2201/0109; F17C 2203/0609; F17C 2203/012; F17C 2205/0119; F17C 2205/0311

(57) ABSTRACT

A pressure vessel made of two thin-walled, closed-end tube sections joined at a central hub that encircles the open ends of the two closed-end tube sections, with a plurality of radial bolts attaching the sections together. The central hub has an O-ring groove in which an O-ring rests, providing a seal between the interior of the pressure vessel and the outside. The inner wall of the central hub may have radially thin and radially thick sections to distribute and minimize weight without sacrificing strength. The assembly may be attached to a mounting surface through a dovetail mount on the central hub.

### CROSS REFERENCE TO RELATED APPLICATIONS

This utility patent application claims priority to U.S. Provisional Application No. 63/233,712, filed Aug. 16, 2021, the contents of which are incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of pressure vessels, and more particularly to novel technology relating to manufacturing of efficient and effective pressure vessels. The pressure vessel described in this application relies on state-of-the-art manufacturing methods including the latest innovations in metal drawing, metal impact extrusion, aluminum extrusion, and high-speed CNC machining. This patent application covers both the method of making the product and the end product itself.

### Background of the Invention

The prior art includes one-piece reservoirs or pressure vessels that are typically manufactured from multiple formed sheet metal components that are all welded together. The problem with welding is that it is costly and cannot eliminate the possibility of leaks—both with the main components as well as additional components such as fitting ports—as well as adding costs to the final product. Current pressure vessels usually have mounting brackets made from formed sheet metal that are welded onto the pressure vessel, which adds to the final cost and complexity of the manufacturing process.

The prior art provides both one-piece and two-piece pressure vessels. The one-piece version, by its design, limits how many additional components can be added, and creates problems with installation and repair. The multi-piece pressure vessel obviously requires a means by which the vessel is closed, which makes these versions relatively expensive and can be difficult to manufacture and repair.

### SUMMARY OF INVENTION

The invention is a modular, multi-piece pressure vessel that basically relies on two end pieces joined at the center under a central hub. This manufacturing method allows for simple post processing, which is both efficient and economical, to allow the drawn or impact extruded component to be inserted into an extruded and machined central hub that define a cavity that can store a pressurized fluid. The central hub and two opposing closed-end tubes create a modular pressure vessel wherein additional features can be integrated into the central hub, such as integrated manifolds and control valves, ports, electrical bulkheads, mounting provisions, integrated air compressor, and electronic modules for a more integrated system. The final product creates an effective pressure vessel to which additional components can be easily added, and also is easily repaired and serviced.

The invention provides a number of improvements over existing technologies. First, air management systems control the height of a vehicle through adding and removing air from the air suspension system(s). Pressure vessels are used to store air, and in combination with an electric air compressor, and electric solenoids and control units, can be used to adjust the height of the vehicle above the axel(s). The problem with the existing technology is that these various components are usually located at different places and mounted individually. The current invention solves this problem by creating the proverbial “all in-one unit”, to which additional components can be mounted either externally and/or internally.

Second, inflating and deflating tires is often of value to off-road and other users. This usually requires an air reservoir (which is a pressure vessel) which is loaded and unloaded with compressed air from an air compressor and controlled by an electronic solenoid that adjusts a valve. The current invention, again by providing a single unit that can contain all the necessary parts, creates a product that is both more efficient and less expensive, with either externally mounted components such as electric air compressors and electronic solenoid valve units, and/or internally secured components such as electric air compressors and electronic solenoid valves.

A third possible use for this technology is to provide superior air supply systems. These portable units are often popular in DIY home garages, at job sites, particular construction job sites, and in factories. Some of the uses are for air-tools, filling tires and filling balls and other sporting gear. The current state-of-the-art systems are noisy, usually large and cumbersome, and heavy. The current invention provided that same air compressor/reservoir and pressure control switch all in a single unit which provides that same quantity of air but in a more aesthetically desirable shape and with significantly less noise.

A fourth possible use is in industrial facilities that require air to power multiple machines. The current systems in use today usually have a central air supply unit with various pipes and other plumbing that distributes air to the various machines. With the current invention, there is no need for the extensive (and expensive) pipe systems, as each machine can have its own “all in one” air supply. The invention also provides a unit with all of its essential components internally secured, which allows for less maintenance.

### Brief Description of Commercial Advantages

Compared to the state-of-the-art designs, the invention provides a single unit with significant advantages in terms of lower manufacturing cost, lower maintenance and repair costs—both in terms of cash expenses and labor—as the current invention's products will need to be maintained and repaired less than the current products on the market today.

More Detailed Description of Commercial Advantages. The current invention relies on a number of technological improvements to provide a product that has significant advantages over the prior art. One such improvement is the use of closed-end tubes to make up the majority (50% or more) of the pressure vessel length. This provides a final product which is lighter and less expensive than current vessels. Because the closed-end vessels are removably secured within the central hub, a “modular” pressure vessel is created, thereby providing improved manufacturability, reliability, serviceability, ease of installation, and appearance over the pressure vessels currently in use. Because different lengths of the closed-end tube sections can be created during the manufacturing process, a series of pressure vessels with different volumes can be created for the different needs of the end user.

The current pressure vessels on the market today also do not create the opportunity to integrate various parts of functions into the pressurized interior of the pressure vessel. By allowing for units such as valves, manifolds, ports, electric bulkheads, etc. into the interior of the pressure vessel, the resulting products is less expensive, lighter, more versatile, easier to maintain and repair, and more robust than the current state-of-the-art.

Current pressure vessels also fail to be designed such that a manufacturer can easily install and access an air compressor within the pressure vessel. By securing an air compressor to the central hub, the resulting products easier to work with, lighter, and more secure.

Current technology in the pressure vessel field also fails to provide for a simplified central mounting location for attaching the pressure vessel to a mounting surface. The current invention utilizes a unique dovetail central mounting technique, that makes installation more efficient and less costly, and allows for flexibility for mounting for different end uses.

Statement of the Problem. To fill the need for a more cost-effective integrated air tank solution.

Solution Presented. By securing two closed-end sections within a central hub, a modular pressure vessel is provided.

Prior Art. The prior art provides the current state-of-the-art in pressure vessel technology. For example, U.S. Ser. No. 10/436,386 to Heon and Heon describes A modular pressure vessel suitable for housing, storage, and/or supplying a pressurized fluid is disclosed. In one aspect, the modular pressure vessel comprises removable end-caps attached to each end of a center section. The center section includes longitudinal rails. In another aspect, methods for manufacturing the modular pressure vessel are described, including extrusion processes for the center section. The modular pressure vessel allows for various components to be easily swapped out or changed, such as the end-caps, or components easily installed and removed from inside the pressure vessel, such as a compressor and related components. This invention requires O-ring seals for each of the end caps where they meet the extruded center section as well as O-ring seals for each of the bolts that retain the end caps to the extruded center section (eight for each end cap as illustrated in the patent). The complex cross-sectional shape of the extruded center section and its overall length (98% of the entire length of the modular pressure vessel) result in a high material cost for the extruded center section. The complexity of the end caps results in a high material cost and high machining cost especially in the case of when pneumatic solenoid valves, manifolding, and air coupling fittings are integrated within each of the end caps. The preferred embodiment of the invention described herein utilizes an extruded center hub with nominal overall length (13% or less than the entire length of the pressure vessel) which significantly reduces the cost over all prior art. Low-cost drawn or impact extruded closed-end tubes are affixed to the center hub by means of blind radial bolts which are located outside of the internal pressure of the vessel eliminating the need for O-ring seals for each of the bolts. Only one O-ring seal is required for sealing each of the closed-end tubes to the center hub. The preferred embodiment further described herein significantly reduces the cost and complexity over the invention described in U.S. Pat. No. 10,436,386B2.

U.S. Pat. No. 3,279,645 to Harvey describes a pressure vessel with an external flange formed into the end of the center section for the purposes of attaching a removable end cap. The manufacturing of such a flange requires either a casting or flange welding manufacturing process which are both undesirable due to cost and reliability.

U.S. Pat. No. 2,548,934A describes a pressure vessel closure method utilizing a split ring V-flange method to attach the end caps to the center section. This method requires the inclusion of a flange at the ends of the center section requiring a manufacturing method of either a casting or flange welding which are both undesirable due to cost and reliability. The manufacturing of the additional split ring clamping member is also undesirable.

U.S. Pat. No. 3,256,069A to Albert and U.S. Pat. No. 4,040,284A to Fuchs describe pressure vessels that utilize tie rods or bolts that pass completely through the center section and end caps in order to enclose the end caps to the center section. These rods or bolts may be internal or external. These designs have the undesirable drawback of requiring far too many parts which increases the cost and difficulty of assembly in addition to an unattractive appearance of the final product.

U.S. Pat. No. 2,766,903A describes a pressure vessel that utilizes bolts to attach the end cap or “cover plate” to the center section. This method requires an unnecessarily thick center section in order to facilitate the material required to form the female threads. A long center tube section that is entirely too thick for the overall pressure requirements of the vessel is undesirable due to the unnecessary material cost and final product weight.

U.S. Ser. No. 10/436,386B2 to Heon and Heon describes the use of pneumatic solenoid valves, manifolding, and air coupling fittings integrated within the modular end caps of the modular pressure vessel. The complexity of manufacturing these end caps results in a high material cost for the end caps and a high machining cost for the end caps. The preferred embodiment of the invention integrates the pneumatic solenoid valves, manifolding, and air coupling fittings into the single center hub of the modular pressure vessel which significantly reduces material cost and machining cost over all prior art.

U.S. Pat. No. 6,834,674B2 to Koscharney and Gobelsmann describes the integration of a means for controlling the release of gas including a shut-off valve. This invention describes the integrated control means as being “mounted to one of the end caps” on the “interior of the vessel housing”. These components are not integrated into one of the other machined components as described in the preferred embodiment.

U.S. Pat. No. 6,675,831 B2 to Sakaguchi et. al., describes the integration of a valve apparatus into an existing pressure vessel outlet. This valve apparatus is a separate component from the pressure vessel which does not offer any of the integration benefits as demonstrated by the preferred embodiment.

U.S. Pat. No. 6,056,007A to Gochenouer and Pickering describes the external integration of a separate air manifold joined to a common welded “one-piece” pressure vessel. The only actual “integration” that this invention offers is only a means for attaching the manifold externally. This preferred embodiment of the invention integrates the manifold and valves entirely into the center hub of the pressure vessel which offers significant benefits.

U.S. Ser. No. 10/436,386B2 to Heon and Heon describes the use of an air compressor inside of a modular pressure vessel. This invention requires that the air compressor be installed and mounted within the long center extruded tube section of the pressure vessel which makes physical access of the compressor mounting locations, wiring connections, and plumbing connections very difficult. The preferred embodiment allows the compressor to be mounted to the center hub of the modular pressure vessel which results in ease of access to the compressor mounting locations, wiring connections, and plumbing connections prior to installing the closed-end tubes to the center hub.

Dovetail joints are widely known for a plethora of non-permanent affixing applications such as firearms, camera gear, machining equipment, industrial equipment, etc. There is no available prior art related to the integration of dovetail joint for affixing a pressure vessel to a mounting surface as described by the preferred embodiment herein.

### Brief Description of Solution Provided by this Invention

The current invention utilizes the thin-wall potential of a drawn or impact extruded closed-end tube to make up the majority (50% or more) of the pressure vessel length which results in decreased weight and material cost. The invention also successfully integrates the pneumatic solenoid valves, manifolding, and air coupling fittings into the single center hub of the modular pressure vessel which significantly reduces material cost and machining cost over all prior art. This design allows the compressor to be mounted to the center hub of the modular pressure vessel which results in ease of access to the compressor mounting locations, wiring connections, and plumbing connections prior to installing the closed-end tubes to the center hub. A final advantage provided by this invention is the integration of dovetail joint for affixing a pressure vessel to a mounting surface as described by the preferred embodiment herein

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is an isometric view of the preferred embodiment modular pressure vessel.

FIG. 2 illustrates the same isometric view of the preferred embodiment modular pressure vessel 1A that is illustrated in FIG. 1, with the central hub 1, radial bolts 3 and dovetail mount 9 removed to better illustrate the removable thin-walled, closed-end tube sections 2 and the array of radial holes 4 configured therein for the purpose of passing the radial bolts 3 through the thin-walled, closed-end tube sections 2.

FIG. 3 is a front section view of FIG. 2 along section line 2B to further illustrate the removable thin-walled, closed-end tube sections 2.

FIG. 4 illustrates a top broken section view of FIG. 1 along section line 3A.

FIG. 5 illustrates a detail view of FIG. 4 at location 3B for the purpose of describing the mechanical retention and sealing interface between the central hub 1 and the removable thin-walled, closed-end tube sections 2 of the preferred embodiment modular pressure vessel 1A.

FIG. 6 illustrates an isometric view of the central hub 1 of the preferred embodiment modular pressure vessel 1A.

FIG. 7 illustrates an extrusion profile view of the central hub 1 of the preferred embodiment modular pressure vessel 1A shown in its extruded state 1E prior to post process machine work operations.

FIG. 8 illustrates an isometric view of a second embodiment of the central hub 1B for use with said modular pressure vessel 1A.

FIG. 9 illustrates the back view of said second embodiment of the central hub 1B

FIG. 10 illustrates an extrusion profile view of the additional embodiment of central hub 1B shown in its extruded state 1F prior to post process machine work operations which includes areas of additional thickness 6C.

FIG. 11 illustrates an exploded isometric view of the central hub 1 and dovetail mounting plate 15 in their uninstalled state for the preferred embodiment modular pressure vessel 1A.

FIG. 12 illustrates a non-exploded isometric view of the central hub 1 and dovetail mounting plate 15 in the installed state for the preferred embodiment modular pressure vessel 1A.

FIG. 13 illustrates an isometric view of an additional embodiment modular pressure vessel 2A which consists of a single removable thin-walled, closed-end tube section 2 that is joined to a closed end central hub 20 to define a cavity configured to store a pressurized fluid therein.

FIG. 14 illustrates a top broken section view of FIG. 13 along section line 7B.

FIG. 15 illustrates an isometric view of an additional embodiment modular pressure vessel 3A which consists of a single removable thin-walled, open-ended tube section 50 that is joined between two closed end central hubs 30 to define a cavity configured to store a pressurized fluid therein.

FIG. 16 illustrates a top broken section view of FIG. 15 along section line 8B.

### DETAILED DESCRIPTION OF THE FIGURES

The present invention is a uniquely designed pressure vessel, utilizing unique and effective/efficient technologies to create a superior, cost-effective product. The various advantages provided by this invention are described more fully with respect to the drawings that have been provided.

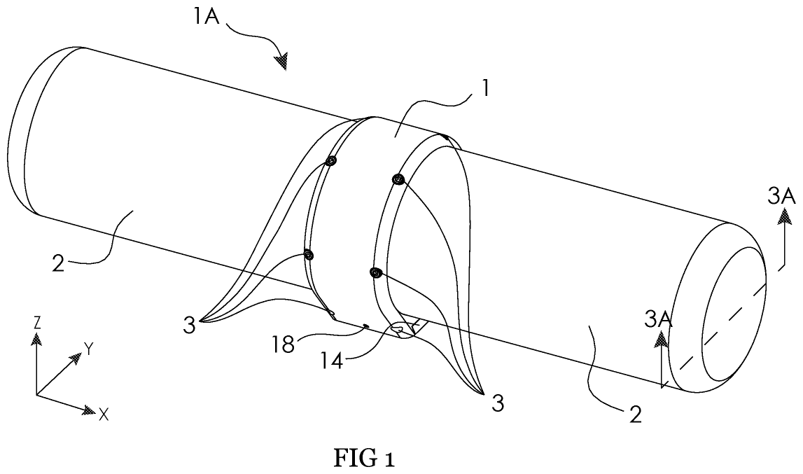

FIG. 1 illustrates an isometric view of the preferred embodiment modular pressure vessel 1A which consists of removable thin-walled, closed-end tube sections 2 that are joined to a central hub 1 to define a cavity configured to store a pressurized fluid therein. The thin-walled, closed-end tube sections 2 may be made of aluminum, steel, stainless steel, carbon fiber or another reinforced composite material and may be manufactured through the process of drawing, metal impact extrusion, molding, forming, or hydroforming all of which are highly efficient. The central hub 1 may be made of aluminum, steel, stainless steel, or composite, and may be manufactured through the process of extrusion, casting, forging, or injection molding all of which are highly efficient. The removable thin-walled, closed-end tube sections 2 are non-permanently affixed to central hub 1 via radial bolts 3 further described herein. The preferred embodiment modular pressure vessel 1A may be affixed to a mounting surface for the application for which the modular pressure vessel 1A will be used via the dovetail mount 14 and set screw 18 further described herein. Simple adjustments to the manufacturing process for the removable thin-walled, closed-end tube sections 2 can yield a variety of X-axis length in order to vary the volume of the modular pressure vessel 1A to fit the requirements of the application. The removable thin-walled, closed-end tube sections 2 sections may be of dissimilar X-axis length if desirable for the application.

FIG. 2 illustrates the same isometric view of the preferred embodiment modular pressure vessel 1A that is illustrated in FIG. 1, with the central hub 1, radial bolts 3 and dovetail mount 9 removed to better illustrate the removable thin-walled, closed-end tube sections 2 and the array of radial holes 4 configured therein for the purpose of passing the radial bolts 3 through the thin-walled, closed-end tube sections 2.

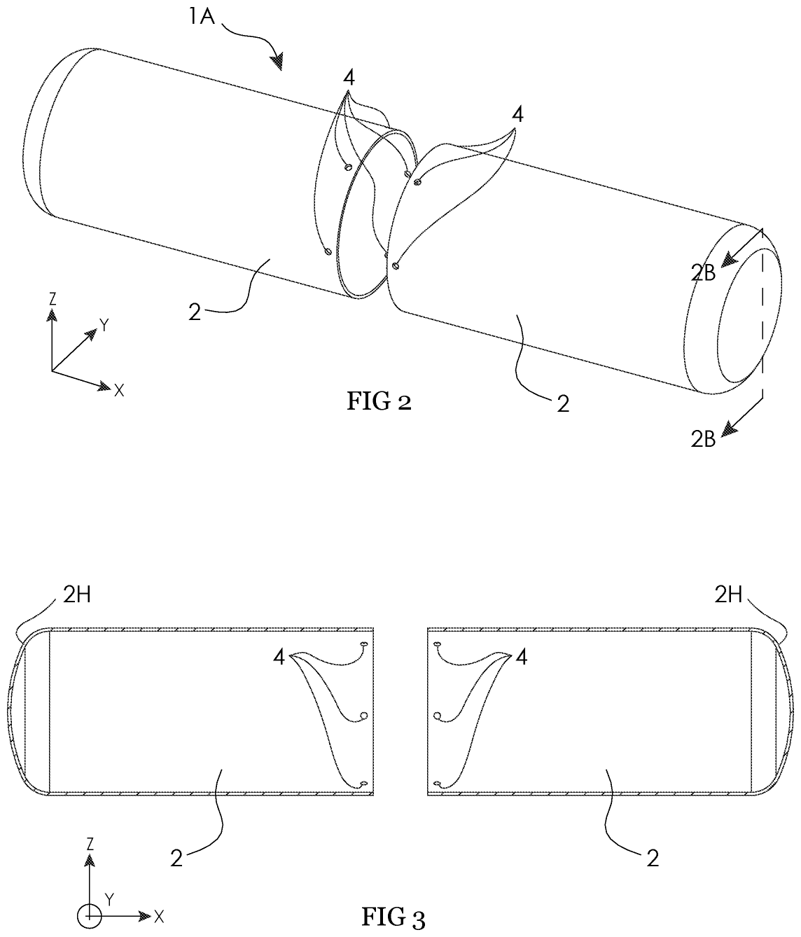

FIG. 3 is a front section view of FIG. 2 along section line 2B to further illustrate the removable thin-walled, closed-end tube sections 2. The minimum radial wall thickness of the removable thin-walled, closed-end tube sections 2 is determined by the yield stress calculations based on the maximum pressure requirements for the pressure vessel and the material of which the removable thin-walled, closed-end tube sections 2 are constructed. The shape or contour of the head portion 2H of the removable thin-walled, closed-end tube section 2 is selected to optimize fatigue and maintain the shape of the head portion 2H based on the maximum pressure requirements for the pressure vessel and the material of which the removable thin-walled, closed-end tube sections 2 are constructed.

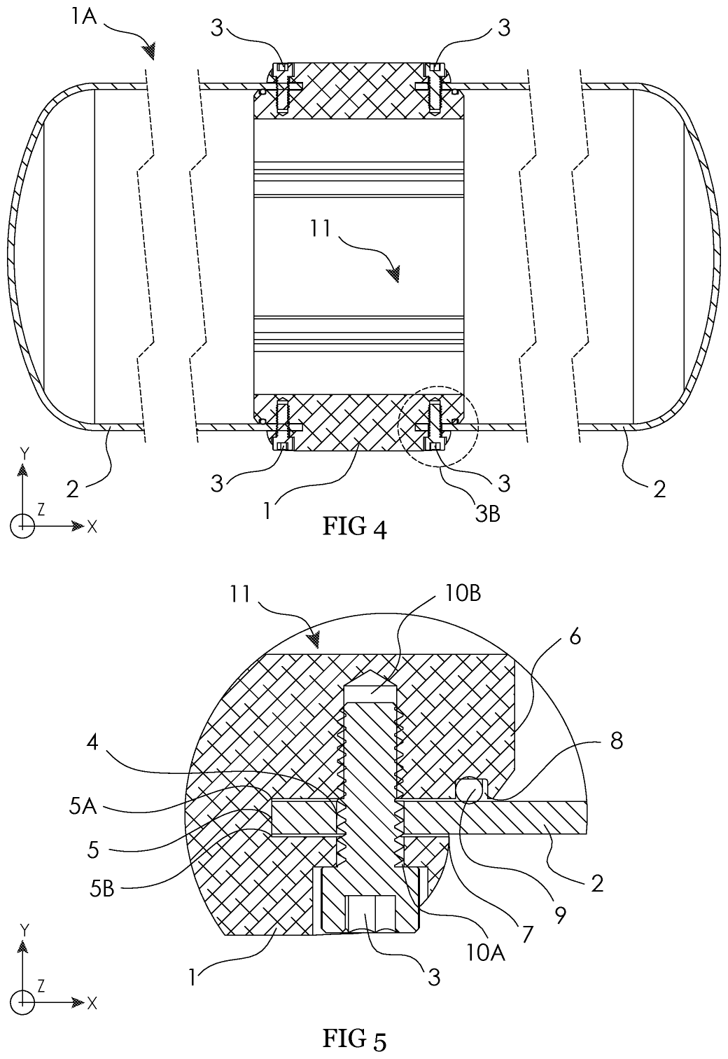

FIG. 4 illustrates a top broken section view of FIG. 1 along section line 3A.

FIG. 5 illustrates a detail view of FIG. 4 at location 3B for the purpose of describing the mechanical retention and sealing interface between the central hub 1 and the removable thin-walled, closed-end tube sections 2 of the preferred embodiment modular pressure vessel 1A. A circumferential groove 5 on each end of the center hub 1 has an inner radius 5A and an outer radius 5B sized to closely receive the wall thickness of the removable thin-walled, closed-end tube sections 2. The depth of the circumferential groove 5 in the X-axis direction is such that a significant portion (0.375 inches or more) of the removable thin-walled, closed-end tube sections 2 is engaged within the groove 5 of central hub 1. The inner wall 6 adjacent to the inner radius 5A extends further than the outer wall edge 7 adjacent to the outer radius 5B in the X-axis direction in order to accommodate the O-ring groove 8. O-ring groove 8 contains an annular O-ring 9 for the purpose of fluidly sealing the central hub 1 to the removable thin-walled, closed-end tube sections 2. Center hub 1 also contains radial holes 10A and radial threads 10B to receive the radial bolts 3 for the purpose of retaining the removable thin-walled, closed-end tube sections 2 within the center hub 1. Radial female threaded hole 10B is a blind hole which does not pass through the inner wall 6 in order to prevent the radial bolts 3 from penetrating the pressurized volume 11 and requiring additional sealing requirements for the radial bolts 3. During assembly of the modular pressure vessel 1A, the radial bolts 3 pass through the radial holes 4 of the removable thin-walled, closed-end tube sections 2 and the radial bolts 3 are torqued in order to generate a sufficient clamping force between the inner radius 5A and the removable thin-walled, closed-end tube sections 2 and the outer radius 5B and the removable thin-walled, closed-end tube sections 2 required to retain the removable thin-walled, closed-end tube sections 2 within the center hub 1 based on the maximum pressure requirements for the pressure vessel. The radial bolts 3 provide additional retention of the removable thin-walled, closed-end tube sections 2 within the center hub 1 through contact between the radial bolts 3 and the radial holes 4.

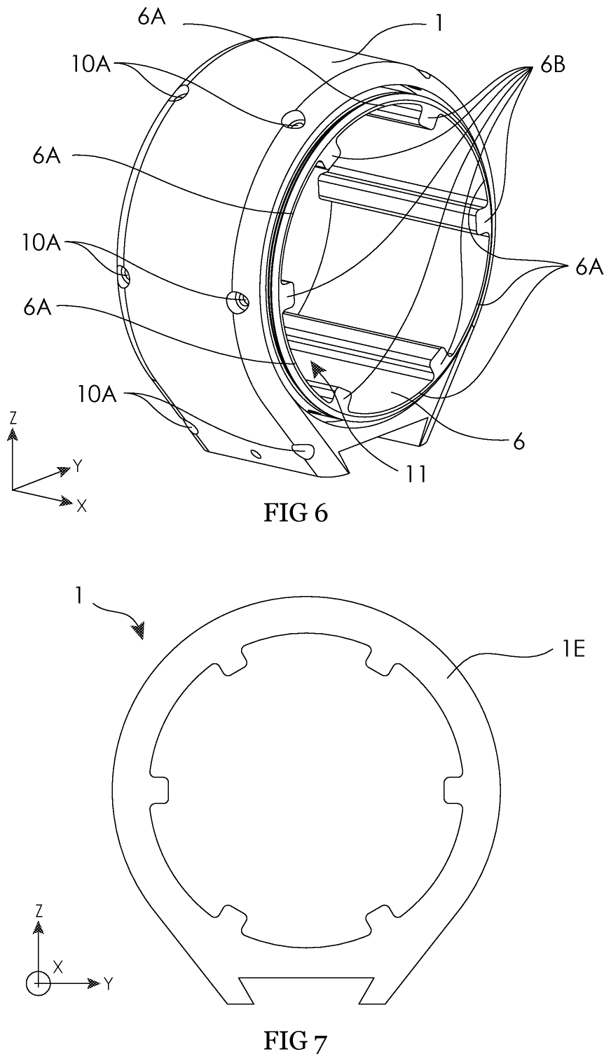

FIG. 6 illustrates an isometric view of the central hub 1 of the preferred embodiment modular pressure vessel 1A. This preferred embodiment of the central hub 1 is manufactured by aluminum extrusion process and then secondary machine work. The inner wall 6 of central hub 1 may have radially thin sections 6A and radially thick sections 6B distributed around the inner circumference for the purpose of material and weight reduction. The radially thick sections 6A may be aligned with radial holes 10A and radial female threaded hole 10B to allow for ample thread depth of the radial female threaded hole 10B without penetrating the interior pressurized volume 11.

FIG. 7 illustrates an extrusion profile view of the central hub 1 of the preferred embodiment modular pressure vessel 1A shown in its extruded state 1E prior to post process machine work operations.

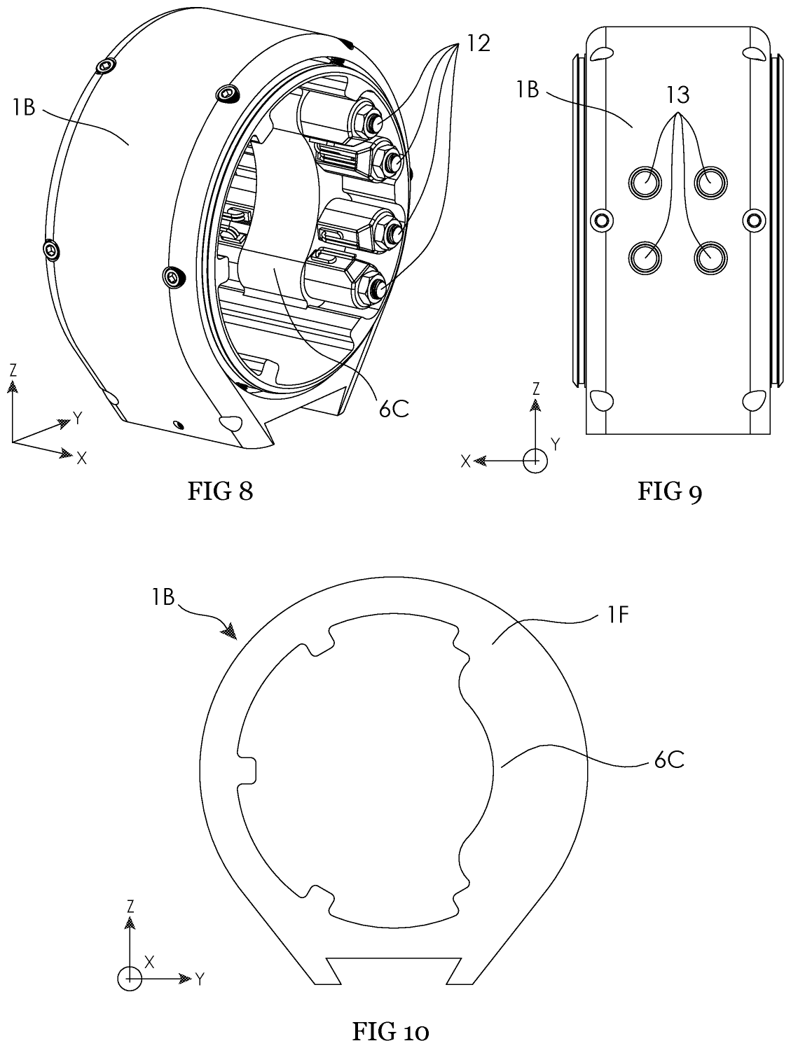

FIG. 8 illustrates an isometric view of a second embodiment of the central hub 1B for use with said modular pressure vessel 1A.

FIG. 9 illustrates the back view of said second embodiment of the central hub 1B. In this embodiment of central hub 1B areas of additional thickness 6C are arranged within said inner wall 6 for the purpose of incorporating pneumatic solenoid valves and manifolding 12 and pneumatic coupling ports 13. The inner wall 6 may contain other radially thick sections (not shown) for the purpose of supporting additional features such as inlet/outlet plumbing ports, bulkheads or connectors for electrical connections, manifolds, mounting provisions, solenoid valves, or additional internally mounted components such as an air compressor.

FIG. 10 illustrates an extrusion profile view of the additional embodiment of central hub 1B shown in its extruded state 1F prior to post process machine work operations which includes areas of additional thickness 6C.

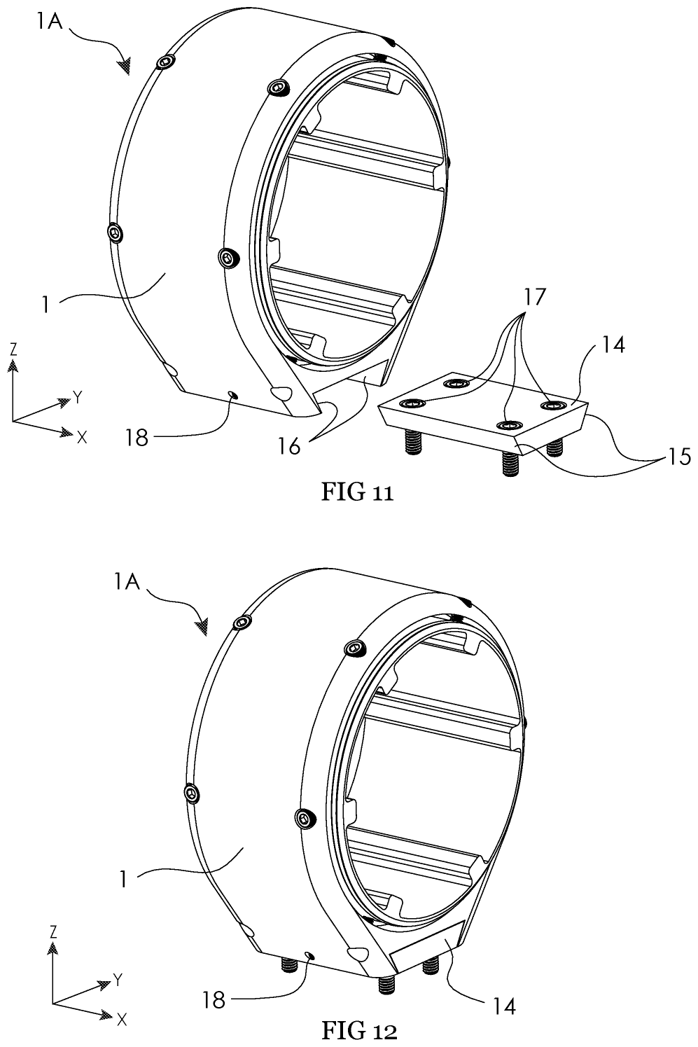

FIG. 11 illustrates an exploded isometric view of the central hub 1 and dovetail mounting plate 15 in their uninstalled state for the preferred embodiment modular pressure vessel 1A. In the unassembled state, the dovetail mounting plate may be attached to the mounting surface of the application for which the modular pressure vessel 1A will be used with mounting bolts 14. The dovetail mounting plate 15 incorporates male negative angled surfaces 15 that interface with female negative angled surfaces 16 incorporated within the central hub 1. Upon installation of the preferred embodiment modular pressure vessel 1A, the user slides center hub 1 over the dovetail mounting plate 15 until fully engaged then tightens set screw 18 in order to secure the modular pressure vessel 1A to the dovetail mounting plate 15.

FIG. 12 illustrates a non-exploded isometric view of the central hub 1 and dovetail mounting plate 15 in the installed state for the preferred embodiment modular pressure vessel 1A.

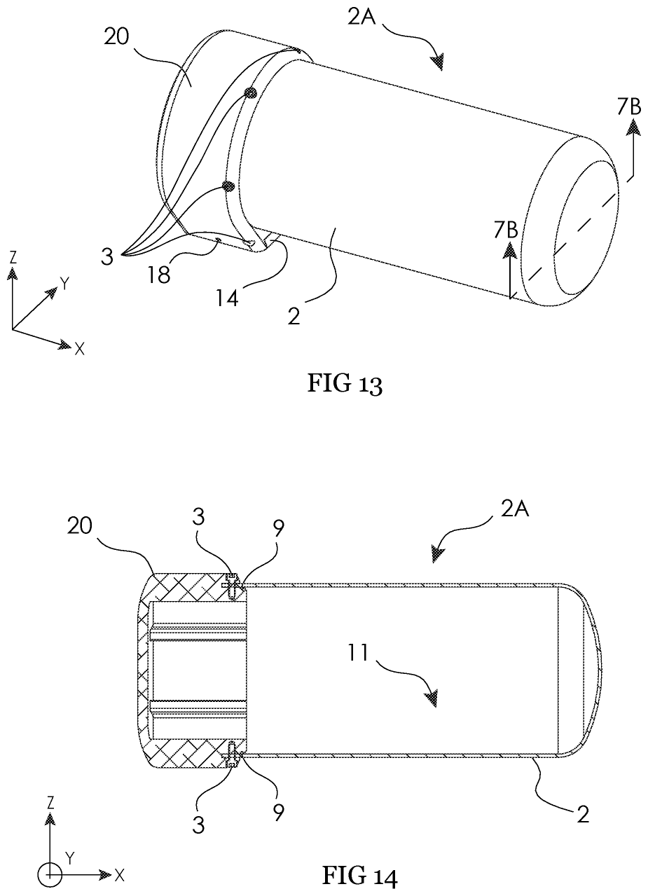

FIG. 13 illustrates an isometric view of an additional embodiment modular pressure vessel 2A which consists of a single removable thin-walled, closed-end tube section 2 that is joined to a closed end central hub 20 to define a cavity configured to store a pressurized fluid therein. The thin-walled, closed-end tube section 2 may be made of aluminum, steel, stainless steel, carbon fiber or another reinforced composite material and may be manufactured through the process of drawing, metal impact extrusion, molding, forming, or hydroforming all of which are highly efficient. The central hub 20 may be made of aluminum, steel, stainless steel, or composite, and may be manufactured through the process of extrusion, casting, forging, or injection molding all of which are highly efficient. The removable thin-walled, closed-end tube section 2 is non-permanently affixed to central hub 20 via radial bolts 3 further described herein. The preferred embodiment modular pressure vessel 2A may be affixed to a mounting surface for the application for which the modular pressure vessel 2A will be used via the dovetail mount 14 and set screw 18 further described herein. Simple adjustments to the manufacturing process for the removable thin-walled, closed-end tube section 2 can yield a variety of X-axis length in order to vary the volume of the modular pressure vessel 2A to fit the requirements of the application.

FIG. 14 illustrates a top broken section view of FIG. 13 along section line 7B.

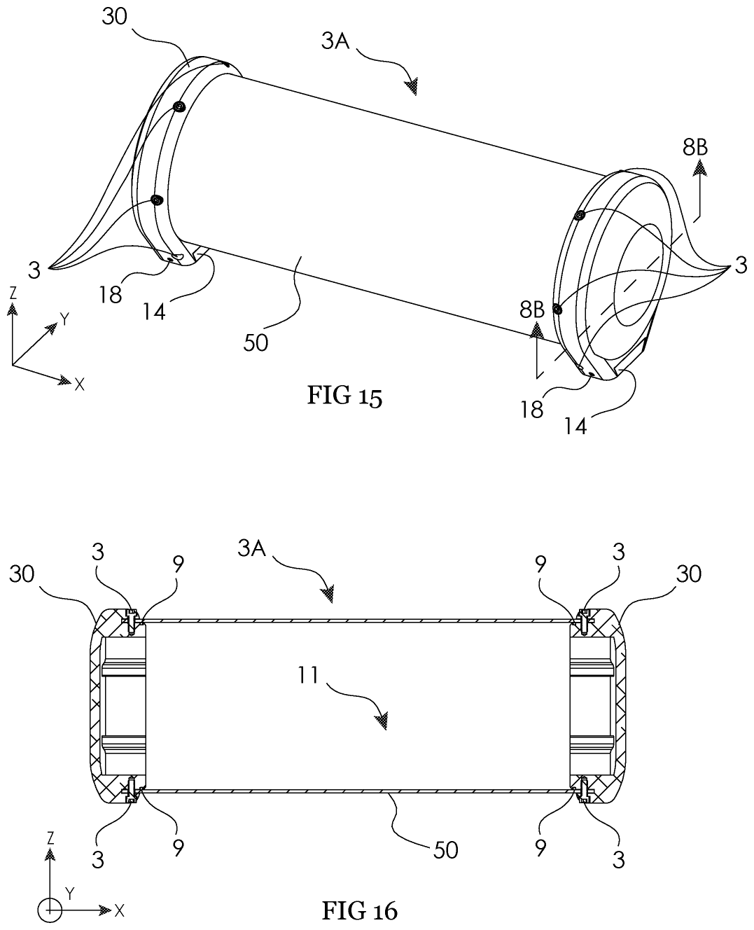

FIG. 15 illustrates an isometric view of an additional embodiment modular pressure vessel 3A which consists of a single removable thin-walled, open-ended tube section 50 that is joined between two closed end central hubs 30 to define a cavity configured to store a pressurized fluid therein.

FIG. 16 illustrates a top broken section view of FIG. 15 along section line 8B.

In some use cases it may be beneficial for the modular pressure vessel to only utilize one removable thin-walled, open-ended tube section arranged with two closed end, or non-hollow variants of the central hub. The remainder of claims from the preferred embodiment may be applied to Alternative #2. FIG. 15 illustrates an isometric view of an additional embodiment modular pressure vessel 3A which consists of a single removable thin-walled, open-ended tube section 50 that is joined between two closed end central hubs 30 to define a cavity configured to store a pressurized fluid therein. The thin-walled, open-ended tube section 50 may be made of aluminum, steel, stainless steel, carbon fiber or another reinforced composite material and may be manufactured through the process of drawing, metal impact extrusion, molding, forming, or hydroforming all of which are highly efficient. The closed end central hubs 30 may be made of aluminum, steel, stainless steel, or composite, and may be manufactured through the process of extrusion, casting, forging, or injection molding all of which are highly efficient. The removable thin-walled, open-ended tube section 50 is non-permanently affixed to central hubs 30 via radial bolts 3 further described herein. The preferred embodiment modular pressure vessel 3A may be affixed to a mounting surface for the application for which the modular pressure vessel 3A will be used via the dovetail mount 14 and set screw 18 further described herein. Simple adjustments to the manufacturing process for the removable thin-walled, open-ended tube section 50 can yield a variation of X-axis length in order to vary the volume of the modular pressure vessel 3A to fit the requirements of the application. FIG. 16 illustrates a top broken section view of FIG. 15 along section line 8B.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

Many aspects of the invention can be better understood with references made to the drawings as attached. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A pressure vessel, comprising: two closed-end tube sections, where each of the two closed end tube sections has a closed end, an open end, and a cylindrical body, and a central hub, where the central hub is a cylindrical band, into which the open ends of the two closed-end tube sections fit and are secured, thereby creating a pressurized volume inside of the pressure vessel.

2. The pressure vessel of claim 1, where the central hub additionally comprises a plurality of radial bolt holes, and where the two closed-end tube sections additionally comprise a plurality of threaded tube holes, where the plurality of radial bolt holes mate with the plurality of threaded tube holes, and additionally comprising a plurality of bolts, where the plurality of bolts attach the two closed-end tube sections to the central hub.

3. The pressure vessel of claim 2, additionally comprising a dovetail mounting surface.

4. The pressure vessel of claim 2, where the central hub additionally comprises two O-ring grooves, and additionally comprising two O-rings, where the two O-rings fit into the two O-ring grooves and seal an interior section of the pressure vessel.

5. The pressure vessel of claim 4, where the central hub has an inner diameter, and where each of the two closed-end sections have an outer diameter, and where the inner diameter of the central hub is slightly larger than the outer diameter of the two closed-end sections.

6. The pressure vessel of claim 5, where each of the two O-ring grooves has a depth, and where the depth is less than a diameter of each O-ring, such that when one of the two closed-end sections is inserted and secured inside of central hub, the O-ring is compressed.

7. The pressure vessel of claim 2, where the central hub comprises at least one thin-walled section and at least one thick-walled section.

8. The pressure vessel of claim 7, where there is at least one female threaded hole, where the at least one female threaded hole is a blind hole, such that one of the bolts does not penetrate into the pressurized volume.

9. The pressure vessel of claim 7, where the central hub additionally comprises at least one area of additional thickness, where the at least one area of additional thickness supports at least one of inlet/outlet plumbing ports, bulkheads, connectors for electrical connections, manifolds, mounting provisions, solenoid valves, or additional internally mounted components such as an air compressor.

10. The pressure vessel of claim 1, where the central hub and the two closed-end tube sections are made from one of aluminum, steel, stainless steel, carbon fiber or another reinforced composite material and may be manufactured through one of the process of drawing, metal impact extrusion, molding, forming, or hydroforming.

11. A method of making a pressure vessel, comprising: first, taking two closed-end tube sections, where each of the two closed end tube sections has a closed end, an open end, and a cylindrical body, and second, taking a central hub, where the central hub is a cylindrical band, and third, putting the open ends of the two closed-end tube sections fit and are secured, thereby creating a pressurized volume inside of the pressure vessel.

12. The method of making a pressure vessel of claim 1, where the central hub additionally comprises a plurality of radial bolt holes, and where the two closed-end tube sections additionally comprise a plurality of threaded tube holes, where the plurality of radial bolt holes mate with the plurality of threaded tube holes, and additionally comprising a plurality of bolts, where the plurality of bolts attach the two closed-end tube sections to the central hub.

13. The method of making a pressure vessel of claim 2, additionally comprising a dovetail mounting surface.

14. The method of making a pressure vessel of claim 2, where the central hub additionally comprises two O-ring grooves, and additionally comprising two O-rings, where the two O-rings fit into the two O-ring grooves and seal an interior section of the pressure vessel.

15. The method of making a pressure vessel of claim 4, where the central hub has an inner diameter, and where each of the two closed-end sections have an outer diameter, and where the inner diameter of the central hub is slightly larger than the outer diameter of the two closed-end sections.

16. The method of making a pressure vessel of claim 5, where each of the two O-ring grooves has a depth, and where the depth is less than a diameter of each O-ring, such that when one of the two closed-end sections is inserted and secured inside of central hub, the O-ring is compressed.

17. The method of making a pressure vessel of claim 2, where the central hub comprises at least one thin-walled section and at least one thick-walled section.

18. The method of making a pressure vessel of claim 7, where there is at least one female threaded hole, where the at least one female threaded hole is a blind hole, such that one of the bolts does not penetrate into the pressurized volume.

19. The method of making a pressure vessel of claim 7, where the central hub additionally comprises at least one area of additional thickness, where the at least one area of additional thickness supports at least one of inlet/outlet plumbing ports, bulkheads, connectors for electrical connections, manifolds, mounting provisions, solenoid valves, or additional internally mounted components such as an air compressor.

20. The method of making a pressure vessel of claim 1, where the central hub and the two closed-end tube sections are made from one of aluminum, steel, stainless steel, carbon fiber or another reinforced composite material and may be manufactured through one of the process of drawing, metal impact extrusion, molding, forming, or hydroforming.

21. A pressure vessel, consisting of: two closed-end tube sections, where each of the two closed end tube sections has a closed end, an open end, and a cylindrical body, and a central hub, where the central hub is a cylindrical band, into which the open ends of the two closed-end tube sections fit and are secured, thereby creating a pressurized volume inside of the pressure vessel, where the central hub additionally comprises a plurality of radial bolt holes, and where the two closed-end tube sections additionally comprise a plurality of threaded tube holes, where the plurality of radial bolt holes mate with the plurality of threaded tube holes, and additionally comprising a plurality of bolts, where the plurality of bolts attach the two closed-end tube sections to the central hub, additionally comprising a dovetail mounting surface, where the central hub additionally comprises two O-ring grooves, and additionally comprising two O-rings, where the two O-rings fit into the two O-ring grooves and seal an interior section of the pressure vessel, where the central hub has an inner diameter, and where each of the two closed-end sections have an outer diameter, and where the inner diameter of the central hub is slightly larger than the outer diameter of the two closed-end sections.

22. The pressure vessel of claim 21, where each of the two O-ring grooves has a depth, and where the depth is less than a diameter of each O-ring, such that when one of the two closed-end sections is inserted and secured inside of central hub, the O-ring is compressed, where the central hub comprises at least one thin-walled section and at least one thick-walled section.

23. The pressure vessel of claim 21, where there is at least one female threaded hole, where the at least one female threaded hole is a blind hole, such that one of the bolts does not penetrate into the pressurized volume, where the central hub additionally comprises at least one area of additional thickness, where the at least one area of additional thickness supports at least one of inlet/outlet plumbing ports, bulkheads, connectors for electrical connections, manifolds, mounting provisions, solenoid valves, or additional internally mounted components such as an air compressor, where the central hub and the two closed-end tube sections are made from one of aluminum, steel, stainless steel, carbon fiber or another reinforced composite material and may be manufactured through one of the processes of drawing, metal impact extrusion, molding, forming, or hydroforming.

24. A method of making a pressure vessel, consisting of the steps of: first, taking two closed-end tube sections, where each of the two closed end tube sections has a closed end, an open end, and a cylindrical body, and second, taking a central hub, where the central hub is a cylindrical band, and third, putting the open ends of the two closed-end tube sections fit and are secured, thereby creating a pressurized volume inside of the pressure vessel, where the central hub additionally comprises a plurality of radial bolt holes, and where the two closed-end tube sections additionally comprise a plurality of threaded tube holes, where the plurality of radial bolt holes mate with the plurality of threaded tube holes, and additionally comprising a plurality of bolts, where the plurality of bolts attach the two closed-end tube sections to the central hub.

25. The method of making a pressure vessel of claim 24, where the central hub additionally comprising a dovetail mounting surface.

26. The method of making a pressure vessel of claim 24, where the central hub additionally comprises two O-ring grooves, and additionally comprising two O-rings, where the two O-rings fit into the two O-ring grooves and seal an interior section of the pressure vessel, where the central hub has an inner diameter, and where each of the two closed-end sections have an outer diameter, and where the inner diameter of the central hub is slightly larger than the outer diameter of the two closed-end sections.

27. The method of making a pressure vessel of claim 26, where each of the two O-ring grooves has a depth, and where the depth is less than a diameter of each O-ring, such that when one of the two closed-end sections is inserted and secured inside of central hub, the O-ring is compressed, where the central hub comprises at least one thin-walled section and at least one thick-walled section, where there is at least one female threaded hole, where the at least one female threaded hole is a blind hole, such that one of the bolts does not penetrate into the pressurized volume.

28. The method of making a pressure vessel of claim 27, where the central hub additionally comprises at least one area of additional thickness, where the at least one area of additional thickness supports at least one of inlet/outlet plumbing ports, bulkheads, connectors for electrical connections, manifolds, mounting provisions, solenoid valves, or additional internally mounted components such as an air compressor, where the central hub and the two closed-end tube sections are made from one of aluminum, steel, stainless steel, carbon fiber or another reinforced composite material and may be manufactured through one of the process of drawing, metal impact extrusion, molding, forming, or hydroforming.
